(19) United States
(12) Patent Application Publication
(10) Pub. No.: US 2026/0326293 A1
(43) Pub. Date: Oct. 22, 2026

(54) CONTROL ARCHITECTURE FOR A MOBILE ROBOT

(71) Applicant: Boston Dynamics, Inc., Waltham, MA (US)

(72) Inventors: Frans Anton Koolen, Cambridge, MA (US); Michael Lutter, Cambridge, MA (US); Scott Kuindersma, Bedford, MA (US); Alberto Rodriguez, Cambridge, MA (US)

(73) Assignee: Boston Dynamics, Inc., Waltham, MA (US)

(21) Appl. No.: 19/419,924

(22) Filed: Dec. 15, 2025

Related U.S. Application Data
(60) Provisional application No. 63/736,965, filed on Dec. 20, 2024.

(51) Int. Cl. B25J 9/16; B25J 13/08

(52) U.S. Cl. CPC B25J 9/1638; B25J 9/1612; B25J 9/162; B25J 9/1664; B25J 13/084

(57) ABSTRACT

A control system for a mobile robot is provided. The control system includes a first controller configured to control movement of the mobile robot to provide dynamic balancing of the mobile robot, a second controller configured to control movement of a first portion of the mobile robot, and a first dynamics module configured to coordinate operation of the first controller and the second controller.

### CROSS-REFERENCE TO RELATED APPLICATIONS

This application claims the benefit under 35 U.S.C. § 119(e) of U.S. Provisional application Ser. No. 63/736,965, filed Dec. 20, 2024, and entitled, “CONTROL ARCHITECTURE FOR A MOBILE ROBOT,” the entire contents of which is incorporated herein by reference.

### FIELD OF THE INVENTION

This disclosure relates specifically to a control architecture for a mobile robot.

### BACKGROUND

A robot is generally defined as a reprogrammable and multifunctional manipulator designed to move material, parts, tools, and/or specialized devices through variable programmed motions to perform one or more tasks. Robots may be manipulators that are physically anchored (e.g., industrial robotic arms), mobile platforms that move throughout an environment (e.g., using legs, wheels, or traction-based mechanisms), or some combination of one or more manipulators and/or one or more mobile platforms. Robots are utilized in a variety of industries including, for example, manufacturing, warehouse logistics, transportation, hazardous environments, exploration, and healthcare.

### SUMMARY

Mobile robots configured to move about an environment on one or more legs, such as humanoid robots or quadruped robots, may require a control system that takes into consideration whole-body dynamics of the robot to enable the robot to dynamically balance, reach, step, etc. It may be desirable to provide such robots the ability to manipulate objects in the environment of the robot while dynamic whole body control of the robot is maintained. Accordingly, the control system of the robot may be configured to control movement of one or more end effector(s) of the robot to enable the robot to perform such object manipulations. The inventors have recognized and appreciated that for some robots (e.g., legged robots), it may be advantageous to compose separate controllers for dynamic whole body movement and object manipulation. For instance, the most relevant parts of the robot (e.g., large central inertial bodies vs. distal end effectors) might be different for whole body vs. end effector control, sensor signals (e.g., proprioception vs. vision/tactile) relied on for whole body vs. end effector control may be different, and/or the relevant events used for control planning may happen at different timings for whole body vs. end effector due to the different inertias experienced by the robot for dynamic balancing compared to object manipulation. Some embodiments of the present disclosure relate to a control architecture for a mobile robot that separates and coordinates simultaneous whole-body control and manipulation control capabilities of a mobile robot.

Some embodiments feature a control system for a mobile robot. The control system includes a first controller configured to control movement of the mobile robot to provide dynamic balancing of the mobile robot, a second controller configured to control movement of a first portion of the mobile robot, and a first dynamics module configured to coordinate operation of the first controller and the second controller.

In one aspect, the first controller is a whole body controller for the mobile robot. In another aspect, the first controller comprises a model-based controller configured to plan movements of the mobile robot over a time horizon. In another aspect, the first controller comprises a learned control policy. In another aspect, the first portion of the mobile robot includes at least one end effector. In another aspect, the first portion of the mobile robot includes at least two end effectors. In another aspect, the second controller is configured to control movement of the first portion of the mobile robot to interact with an environment of the mobile robot. In another aspect, the second controller is configured to control movement of the first portion of the mobile robot to grasp and/or manipulate an object.

In another aspect, the second controller comprises a learned control policy. In another aspect, the learned control policy comprises a policy trained using reinforcement learning. In another aspect, the first dynamics module comprises an impedance module. In another aspect, the first controller is configured to provide reference trajectory information and learned control policy information. In another aspect, the reference trajectory information comprises position and/or velocity information for the first portion of the mobile robot. In another aspect, the first portion of the mobile robot includes a base member and at least one downstream member distal from the base member, and the reference trajectory information includes an SE(3) pose reference trajectory for the base member, and a joint position reference trajectory for the at least one downstream member. In another aspect, the learned control policy information comprises stiffness and/or damping information used during training of the learned control policy. In another aspect, the first portion of the mobile robot includes a base member and at least one downstream member distal from the base member, and the learned control policy information includes SE(3) stiffness and/or damping information used during training of the learned control policy to control the base member, and joint space stiffness and/or damping information used during training of the learned control policy to control the at least one downstream member.

In one aspect, the control system further includes a third controller configured to control movement of a second portion of the mobile robot, and a second dynamics module configured to coordinate operation of the first controller and the third controller. In another aspect, the second portion of the mobile robot includes at least one end effector. In another aspect, the second portion of the mobile robot includes at least two end effectors. In another aspect, the first dynamics module is configured to coordinate operation of the first controller and the second controller by specifying impedance information at an interface between the first controller and the second controller.

Some embodiments feature a robot. The robot includes a body, a set of articulated appendages coupled to the body, the set of articulated appendages including at least one leg and a first robotic arm, the first robotic arm including a first wrist joint coupling a first end effector to the first robotic arm, a whole body controller configured to manage whole body dynamics of the robot, and a first end effector controller configured to control movement of the first end effector based on a first learned policy trained independently of the whole body dynamics of the robot.

In one aspect, managing whole body dynamics of the robot comprises controlling the robot to perform dynamic balancing. In another aspect, managing whole body dynamics of the robot comprises controlling the robot to perform locomotion. In another aspect, controlling movement of the first end effector comprises controlling movement of the first end effector to interact with an environment of the robot. In another aspect, controlling movement of the first end effector to interact with an environment of the robot comprises controlling movement of the first end effector to manipulate an object. In another aspect, the first end effector comprises a gripper, and controlling movement of the first end effector to manipulate an object comprises one or more of grasping the object, in-gripper manipulation of the object, using a grasped object to perform a task, or releasing the object from a grasp of the gripper.

In another aspect, the set of articulated appendages further includes a second robotic arm including a second wrist joint coupling a second end effector to the second robotic arm, and the robot further includes a second end effector controller configured to control movement of the second end effector based on a second learned policy trained independently of the whole body dynamics of the robot. In another aspect, the first learned policy and the second learned policy are configured to enable the robot to perform a bimanual interaction with an environment of the robot using the first end effector and the second end effector. In another aspect, the set of articulated appendages further includes a second robotic arm including a second wrist joint coupling a second end effector to the second robotic arm, and a first end effector controller is further configured to control movement of the second end effector based on the first learned policy or a second learned policy.

In another aspect, the whole body controller is configured to manage whole body dynamics of the robot over a first time horizon of at least one second, and the first end effector controller is configured to plan movements of the first end effector over a second time horizon less than one second. In another aspect, the whole body controller comprises a model-based controller. In another aspect, the model-based controller comprises a model predictive controller. In another aspect, the first end effector comprises at least one tactile sensor, and the first end effector controller is further configured to control movement of the first end effector based on data sensed by the at least one tactile sensor.

In another aspect, the first end effector controller is configured to provide reference trajectory information for the first end effector and first learned policy information to the whole body controller. In another aspect, the reference trajectory information comprises position and/or velocity information for the first end effector of the robot. In another aspect, the first end effector includes a base member and at least one downstream member distal from the base member, and the reference trajectory information includes an SE(3) pose reference trajectory for the base member, and a joint position reference trajectory for the at least one downstream member. In another aspect, the first learned policy information comprises stiffness and/or damping information used during training of the first learned policy. In another aspect, the first end effector includes a base member and at least one downstream member distal from the base member, and the first learned policy information includes SE(3) stiffness and/or damping information used during training of the first learned policy to control the base member, and joint space stiffness and/or damping information used during training of the first learned policy to control the at least one downstream member.

Some embodiments feature a method of controlling an end effector of a mobile robot. The method includes controlling, using a local controller, movement of the end effector based, at least in part, on a local learned policy trained independently of whole body dynamics of the mobile robot, and providing reference trajectory information for the end effector from the local controller to a whole body controller configured to control whole body dynamics of the mobile robot.

Some embodiments feature a method of controlling a legged robot. The method includes controlling, with a whole body controller, whole body dynamics of the legged robot, and controlling, using a local controller associated with an end effector of the legged robot, movement of the end effector to interact with an environment of the legged robot while the whole body controller performs whole body control of the legged robot.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIG. 1 illustrates a configuration of a robotic system, according to an illustrative embodiment of the invention.

FIG. 2A shows an example of a humanoid robot, according to an illustrative embodiment of the invention.

FIG. 2B shows an example of various actuators of a humanoid robot, according to an illustrative embodiment of the invention.

FIG. 3A shows a first example control architecture for a robot, according to an illustrative embodiment of the invention.

FIG. 3B shows a second example control architecture for a robot, according to an illustrative embodiment of the invention.

FIG. 3C shows a third example control architecture for a robot, according to an illustrative embodiment of the invention.

FIG. 3D shows a fourth example control architecture for a robot, according to an illustrative embodiment of the invention.

FIG. 4 schematically illustrates a model-based control architecture for a robot, according to an illustrative embodiment of the invention.

FIG. 5 schematically illustrates a system configured to control a robot, according to an illustrative embodiment of the invention.

FIG. 6 is a flowchart of a process for coordinating control of a local controller and whole body controller, according to an illustrative embodiment of the invention.

FIGS. 7A-7F illustrate a robot configured to implement a control architecture including a local controller and a whole body control, according to an illustrative embodiment of the invention.

FIG. 8 is a flowchart of a process for controlling an end effector of a robot based on a learned policy, according to an illustrative embodiment of the invention.

### DETAILED DESCRIPTION

The following detailed description describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

The utility, flexibility and/or scalability of mobile robots (e.g., humanoid robots) to perform various useful tasks may depend on the robots' ability to autonomously perform manipulation tasks such as moving objects, operating mechanisms, using tools, or assembly while the robot is controlled to perform dynamic whole body control. Successful implementation of autonomous manipulation tasks may rely on precise end effector control in situations where robot-object dynamics are uncertain and/or are poorly observed by the sensors (e.g., in the vision system) of the robot. For example, accurate control of an end effector of a robot to securely grasp an object may be affected by the interactions between the frictional surface(s) of the end effector and one or more surfaces of the object, which may have unknown properties. A control system of the robot may include a manipulation policy that governs how the various members of the end effector should move to grasp the object. The manipulation policy may be hard coded (e.g., hand authored by a human) or learned by training a machine learning model to provide a desired control output (e.g., to grasp the object). The control system of the robot may include a set or library of manipulation policies that enable the end effector of the robot to perform different manipulations with the same or different objects in the robot's environment.

Some mobile robots (e.g., legged robots) move about their environment by implementing whole body control algorithms to achieve, for example, performant balancing, reaching, stepping, force rendering, etc. For instance, mobile robots may include a whole-body controller configured to output control instructions to actuators located at a plurality of joints of the robot to achieve such coordinated whole body behaviors.

The inventors have recognized and appreciated that implementing robotic manipulation capabilities on a robot that also requires whole body coordination (e.g., to achieve dynamic balance), such as a humanoid or quadruped robot, may result in a tension between a need for whole-body reasoning of the robot's momentum and kinematic configuration and a need for end-effector centric reasoning to control an interaction of the end effector with the robot's environment. Simultaneously satisfying both of these needs with a single controller may be challenging. Some conventional mobile robots decouple these problems by permitting only one of robot locomotion/whole body control or object manipulation at time, such that the robot is required to assume a reduced control mode when manipulating objects (e.g., the robot is not doing whole-body reconfiguration or is not stepping while also manipulating an object). Such an approach may be restrictive by not permitting a wide range of manipulation tasks that may be useful for a mobile robot to perform. To this end, some embodiments of the present disclosure relate to a control architecture for a robot that separates whole body control (e.g., for dynamic balancing) from local end effector control (e.g., for object manipulation). Coordination between these two control regimes is achieved by implementing a “contract” or “module” that both controllers impose at their respective interface. In some embodiments, the contract/module may be implemented as a software module configured to be executed by at least one hardware processor. It should be appreciated that the terms “dynamics contract” and “dynamics module” are used interchangeably herein and should be interpreted consistently as such.

Separation of whole body control from end effector control for a mobile robot according to some embodiments of the present disclosure may have various advantages relative to a single controller approach. Examples of such advantages include, but are not limited to, the ability to use and/or train smaller and/or less complex manipulation policies, the ability to learn a large and/or varied number of manipulation policies without having to reconfigure or relearn whole body dynamics required for balancing, reaching, or locomotion, the ability to integrate sensor data (e.g., tactile and/or visual sensor data) in closed loop local end effector control, the ability to implement manipulation policies learned for one robot on another robot (e.g., an earlier version of a similar robot, a robot with a different configuration), the ability to replace the whole-body controller of a robot without having to reconfigure or relearn manipulation policies, the ability to use swappable end effectors, each with their own fine-tuned learned manipulation policies, on a single robot body platform, and the ability to perform control planning using different time horizons for whole body vs. end effector control, among other advantages.

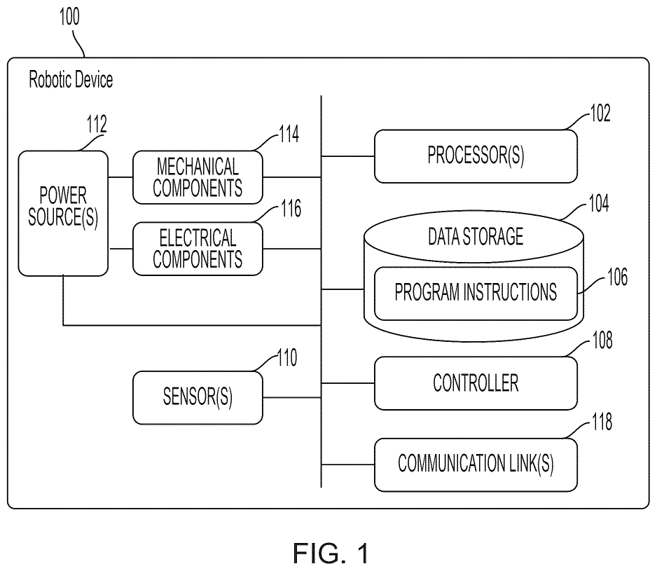

Referring now to the figures, FIG. 1 illustrates an example configuration of a robotic device (or “robot”) 100, according to an illustrative embodiment of the invention. The robotic device 100 represents an example robotic device configured to perform the operations described herein. Additionally, the robotic device 100 may be configured to operate autonomously, semi-autonomously, and/or using directions provided by user(s), and may exist in various forms, such as a humanoid robot, biped, quadruped, or other mobile robot, among other examples. Furthermore, the robotic device 100 may also be referred to as a robotic system, mobile robot, or robot, among other designations.

As shown in FIG. 1, the robotic device 100 includes processor(s) 102, data storage 104, program instructions 106, controller 108, sensor(s) 110, power source(s) 112, mechanical components 114, and electrical components 116. The robotic device 100 is shown for illustration purposes and may include more or fewer components without departing from the scope of the disclosure herein. The various components of robotic device 100 may be connected in any manner, including via electronic communication means, e.g., wired or wireless connections. Further, in some examples, components of the robotic device 100 may be positioned on multiple distinct physical entities rather than on a single physical entity. Other example illustrations of robotic device 100 may exist as well.

Processor(s) 102 may operate as one or more general-purpose processor or special purpose processors (e.g., digital signal processors, application specific integrated circuits, etc.). The processor(s) 102 can be configured to execute computer-readable program instructions 106 that are stored in the data storage 104 and are executable to provide the operations of the robotic device 100 described herein. For instance, the program instructions 106 may be executable to provide operations of controller 108, where the controller 108 may be configured to cause activation and/or deactivation of the mechanical components 114 and the electrical components 116. The processor(s) 102 may operate and enable the robotic device 100 to perform various functions, including the functions described herein.

The data storage 104 may exist as various types of storage media, such as a memory. For example, the data storage 104 may include or take the form of one or more computer-readable storage media that can be read or accessed by processor(s) 102. The one or more computer-readable storage media can include volatile and/or non-volatile storage components, such as optical, magnetic, organic or other memory or disc storage, which can be integrated in whole or in part with processor(s) 102. In some implementations, the data storage 104 can be implemented using a single physical device (e.g., one optical, magnetic, organic or other memory or disc storage unit), while in other implementations, the data storage 104 can be implemented using two or more physical devices, which may communicate electronically (e.g., via wired or wireless communication). Further, in addition to the computer-readable program instructions 106, the data storage 104 may include additional data such as diagnostic data, among other possibilities.

The robotic device 100 may include at least one controller 108, which may interface with the robotic device 100. The controller 108 may serve as a link between portions of the robotic device 100, such as a link between mechanical components 114 and/or electrical components 116. In some instances, the controller 108 may serve as an interface between the robotic device 100 and another computing device. Furthermore, the controller 108 may serve as an interface between the robotic device 100 and a user(s). The controller 108 may include various components for communicating with the robotic device 100, including one or more joysticks or buttons, among other features. The controller 108 may perform other operations for the robotic device 100 as well. Other examples of controllers may exist as well.

Additionally, the robotic device 100 includes one or more sensor(s) 110 such as force sensors, proximity sensors, motion sensors, load sensors, position sensors, touch sensors, depth sensors, ultrasonic range sensors, and/or infrared sensors, among other possibilities. The sensor(s) 110 may provide sensor data to the processor(s) 102 to allow for appropriate interaction of the robotic device 100 with the environment as well as monitoring of operation of the systems of the robotic device 100. The sensor data may be used in evaluation of various factors for activation and deactivation of mechanical components 114 and electrical components 116 by controller 108 and/or a computing system of the robotic device 100.

The sensor(s) 110 may provide information indicative of the environment of the robotic device for the controller 108 and/or computing system to use to determine operations for the robotic device 100. For example, the sensor(s) 110 may capture data corresponding to the terrain of the environment or location of nearby objects, which may assist with environment recognition and navigation, etc. In an example configuration, the robotic device 100 may include a sensor system that may include a camera, RADAR, LIDAR, time-of-flight camera, global positioning system (GPS) transceiver, and/or other sensors for capturing information of the environment of the robotic device 100. The sensor(s) 110 may monitor the environment in real-time and detect obstacles, elements of the terrain, weather conditions, temperature, and/or other parameters of the environment for the robotic device 100.

Further, the robotic device 100 may include other sensor(s) 110 configured to receive information indicative of the state of the robotic device 100, including sensor(s) 110 that may monitor the state of the various components of the robotic device 100. The sensor(s) 110 may measure activity of systems of the robotic device 100 and receive information based on the operation of the various features of the robotic device 100, such the operation of extendable legs, arms, or other mechanical and/or electrical features of the robotic device 100. The sensor data provided by the sensors may enable the computing system of the robotic device 100 to determine errors in operation as well as monitor overall functioning of components of the robotic device 100.

For example, the computing system may use sensor data to determine the stability of the robotic device 100 during operations as well as measurements related to power levels, communication activities, components that require repair, among other information. As an example configuration, the robotic device 100 may include gyroscope(s), accelerometer(s), and/or other possible sensors to provide sensor data relating to the state of operation of the robotic device. Further, sensor(s) 110 may also monitor the current state of a function, such as a gait, that the robotic device 100 may currently be operating. Additionally, the sensor(s) 110 may measure a distance between a given robotic leg of a robotic device and a center of mass of the robotic device. Other example uses for the sensor(s) 110 may exist as well.

Additionally, the robotic device 100 may also include one or more power source(s) 112 configured to supply power to various components of the robotic device 100. Among possible power systems, the robotic device 100 may include a hydraulic system, electrical system, batteries, and/or other types of power systems. As an example illustration, the robotic device 100 may include one or more batteries configured to provide power to components via a wired and/or wireless connection. Within examples, components of the mechanical components 114 and electrical components 116 may each connect to a different power source or may be powered by the same power source. Components of the robotic device 100 may connect to multiple power sources as well.

Within example configurations, any type of power source may be used to power the robotic device 100, such as a gasoline and/or electric engine. Further, the power source(s) 112 may charge using various types of charging, such as wired connections to an outside power source, wireless charging, combustion, or other examples. Other configurations may also be possible. Additionally, the robotic device 100 may include a hydraulic system configured to provide power to the mechanical components 114 using fluid power. Components of the robotic device 100 may operate based on hydraulic fluid being transmitted throughout the hydraulic system to various hydraulic motors and hydraulic cylinders, for example. The hydraulic system of the robotic device 100 may transfer a large amount of power through small tubes, flexible hoses, or other links between components of the robotic device 100. Other power sources may be included within the robotic device 100.

Mechanical components 114 can represent hardware of the robotic device 100 that may enable the robotic device 100 to operate and perform physical functions. As a few examples, the robotic device 100 may include actuator(s), extendable leg(s) (“legs”), arm(s), wheel(s), one or multiple structured bodies for housing the computing system or other components, and/or other mechanical components. The mechanical components 114 may depend on the design of the robotic device 100 and may also be based on the functions and/or tasks the robotic device 100 may be configured to perform. As such, depending on the operation and functions of the robotic device 100, different mechanical components 114 may be available for the robotic device 100 to utilize. In some examples, the robotic device 100 may be configured to add and/or remove mechanical components 114, which may involve assistance from a user and/or other robotic device. For example, the robotic device 100 may be initially configured with four legs, but may be altered by a user or the robotic device 100 to remove two of the four legs to operate as a biped. Other examples of mechanical components 114 may be included.

The electrical components 116 may include various components capable of processing, transferring, providing electrical charge or electric signals, for example. Among possible examples, the electrical components 116 may include electrical wires, circuitry, and/or wireless communication transmitters and receivers to enable operations of the robotic device 100. The electrical components 116 may interwork with the mechanical components 114 to enable the robotic device 100 to perform various operations. The electrical components 116 may be configured to provide power from the power source(s) 112 to the various mechanical components 114, for example. Further, the robotic device 100 may include electric motors. Other examples of electrical components 116 may exist as well.

In some implementations, the robotic device 100 may also include communication link(s) 118 configured to send and/or receive information. The communication link(s) 118 may transmit data indicating the state of the various components of the robotic device 100. For example, information read in by sensor(s) 110 may be transmitted via the communication link(s) 118 to a separate device. Other diagnostic information indicating the integrity or health of the power source(s) 112, mechanical components 114, electrical components 116, processor(s) 102, data storage 104, and/or controller 108 may be transmitted via the communication link(s) 118 to an external communication device.

In some implementations, the robotic device 100 may receive information at the communication link(s) 118 that is processed by the processor(s) 102. The received information may indicate data that is accessible by the processor(s) 102 during execution of the program instructions 106, for example. Further, the received information may change aspects of the controller 108 that may affect the behavior of the mechanical components 114 or the electrical components 116. In some cases, the received information indicates a query requesting a particular piece of information (e.g., the operational state of one or more of the components of the robotic device 100), and the processor(s) 102 may subsequently transmit that particular piece of information back out the communication link(s) 118.

In some cases, the communication link(s) 118 include a wired connection. The robotic device 100 may include one or more ports to interface the communication link(s) 118 to an external device. The communication link(s) 118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

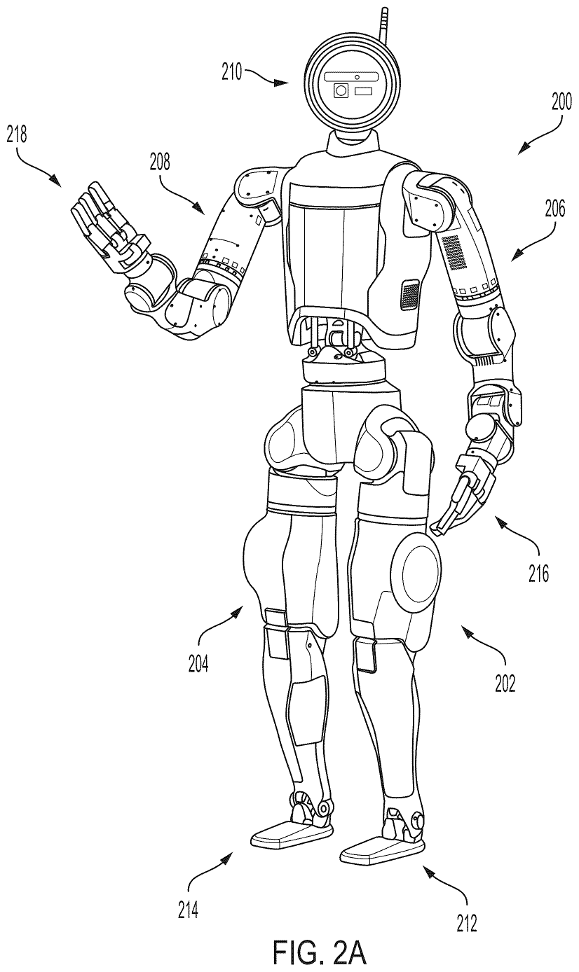

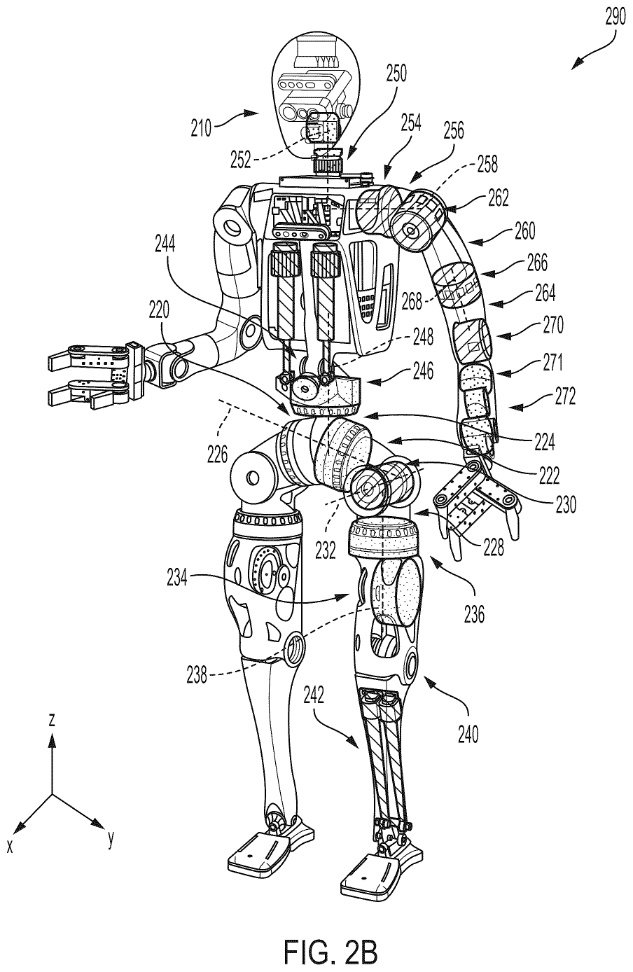

FIG. 2A illustrates an example of a humanoid robot, according to an illustrative embodiment of the invention. The robot 200 may correspond to the robotic device 100 shown in FIG. 1. The robot 200 serves as a possible implementation of a robotic device that may be configured to include the systems and/or carry out the methods described herein. Other example implementations of robotic devices may exist.

The robot 200 may include a number of articulated appendages, such as robotic legs 202, 204 and/or robotic arms 206, 208. The robot 200 may also include a robotic head 210, which may contain one or more vision sensors (e.g., cameras, infrared sensors, object sensors, range sensors, etc.). Each articulated appendage may include a number of (e.g., one, two, three or more) members connected by joints that allow the articulated appendage to move through certain degrees of freedom. For example, each robotic leg 202, 204 may include a respective foot 212, 214, which may contact a surface (e.g., a ground surface). The legs 202, 204 may enable the robot 200 to travel at various speeds according to various gaits. In addition, each robotic arm 206, 208 may facilitate object manipulation, load carrying, and/or balancing of the robot 200. Each arm 206, 208 may also include one or more members connected by joints and may be configured to operate with various degrees of freedom. Each arm 206, 208 may also include a respective end effector (e.g., gripper, hand, etc.) 216, 218. The robot 200 may use end effectors 216, 218 for interacting with (e.g., gripping, turning, pulling, and/or pushing) objects. Each end effector 216, 218 may include various types of appendages or attachments, such as fingers, attached tools or grasping mechanisms. In some embodiments, one or more sensors (e.g., cameras, infrared sensors, object sensors, range sensors, etc.) may be arranged on an arbitrary member or link of the robot.

Robot 200 may also include sensors to measure the angles of the joints of its articulated appendages. In addition, the articulated appendages may include a number of actuators that can be controlled to extend and retract members of the articulated appendages. Examples of actuators that may be included in robot 200 are described in more detail in FIG. 2B. In some cases, the angle of a joint may be determined based on the extent of protrusion or retraction of a given actuator. In some instances, the joint angles may be inferred from position data of inertial measurement units (IMUs) mounted on the members of an articulated appendage. In some implementations, the joint angles may be measured using rotary position sensors, such as rotary encoders. In other implementations, the joint angles may be measured using optical reflection techniques. Other joint angle measurement techniques may also be used.

In some embodiments, robot 200 may include a set of continuous rotation joints, where each continuous rotation joint permits continuous (e.g., 360 degree and/or limitless) rotation about a corresponding axis. Rather than requiring such joints to “unwind” by, for example, always determining a target joint angle relative to a nominal (e.g., 0 degree) orientation, a control system of the robot 200 may be configured to determine that the target joint angle be set at any multiple of 360 degrees (e.g., 0 degrees, 360 degrees, 620 degrees) to permit efficient movement of an attached member about the joint to achieve the target joint angle. For instance, if a target joint angle of a continuous rotation joint is 15 degrees and the current joint angle is 350 degrees, rather than rotating an attached member −335 degrees about the joint, the attached member can instead be rotated +25 degrees (to 375 degrees), which is equivalent to a joint angle of 15 degrees for a continuous rotation joint.

In some embodiments, robot 200 may include a body (e.g., a torso and a base such as a pelvis base) and one or more kinematic chains of robot members (e.g., arms, legs) coupled to the body. Each of the plurality of kinematic chains of robot members may include at least two joints (e.g., a first joint coupling the kinematic chain to the body and a second joint coupling at least two members of the kinematic chain). At least one of the at least two joints in a kinematic chain may be a continuous rotation joint that enables continuous rotation of at least one of the members (and possibly all members if the joint that couples the kinematic member to the body is a continuous rotation joint) of the kinematic chain about the joint. In some embodiments, a kinematic chain may include a single member/link/rigid body.

Robot 200 may be configured to send sensor data from the articulated appendages to a device coupled to robot 200 such as a processing system, a computing system, or a control system. Robot 200 may include a memory, either included in a device on robot 200 or as a standalone component, on which sensor data is stored. In some implementations, the sensor data is retained in the memory for a certain amount of time. In some cases, the stored sensor data may be processed or otherwise transformed for use by a control system on robot 200. In some cases, robot 200 may also transmit the sensor data over a wired or wireless connection (or other electronic communication means) to an external device.

FIG. 2B illustrates an example of a humanoid robot 290, according to an illustrative embodiment of the invention. Humanoid robot 290 may include components (e.g., arms, legs, feet, head) similar to robot 200 of FIG. 2A, which may not be relabeled in FIG. 2B to reduce clutter. Overlaid on the depiction of humanoid robot 290 are a set of actuators that may be used to move an attached member at corresponding joints of the humanoid robot 290 to enable movement of the robot. As described in more detail below, humanoid robot 290 may include different types of actuators and joints that enable different members of the robot to move with varying degrees of freedom, permitting flexibility of movement when desired while restricting movement as appropriate to, for example, avoid or reduce the risk of collisions between robot components.

Humanoid robot 290 includes a base member (e.g., a pelvis base, as shown in FIG. 2B) 220. The pelvis base 220 is rotatably connected to a first hip member 222. An electric actuator 224 may be disposed between the pelvis base 220 and the first hip member 222 (e.g., in, between, connected to, and/or as part of one or both components). In some embodiments, a first portion of the electric actuator 224 may be fixed to the pelvis base 220, and a second portion of the electric actuator 224 may be fixed to the first hip member 222. The electric actuator 224 may be configured to rotate the pelvis base 220 relative to the first hip member 222 about an axis (e.g., a first hip-y axis) 226. The first hip member 222 is also connected to a first intermediate leg member 228. An electric actuator 230 may be disposed between the first hip member 222 and the first intermediate leg member 228 (e.g., in, between, connected to, and/or as part of one or both components). In some embodiments, a first portion of the electric actuator 230 may be fixed to the first hip member 222, and a second portion of the electric actuator 230 may be fixed to the first intermediate leg member 228. The electric actuator 230 may be configured to rotate the first hip member 222 relative to the first intermediate leg member 228 about an axis (e.g., a first hip-x axis) 232. The first intermediate leg member 228 is also connected to a first leg member 234. An electric actuator 236 may be disposed between the first intermediate member 228 and the first leg member 234 (e.g., in, between, connected to, and/or as part of one or both components). In some embodiments, a first portion of the electric actuator 236 may be fixed to the first intermediate member 228, and a second portion of the electric actuator 236 may be fixed to the first leg member 234. The electric actuator 236 may be configured to rotate the first intermediate leg member 228 relative to the first leg member 234 about an axis (e.g., a first hip-z axis) 238. In some embodiments, a second hip member, second intermediate leg member, and second leg member are connected in similar fashion to the first hip member, first intermediate leg member, and first leg member, using similar actuators rotating along similar additional axes and/or providing similar independently actuatable degrees of freedom.

The axis 226 may be referred to as a first hip-y axis, which denotes a flexion/extension axis of the robot 200. The axis 232 may be referred to as a first hip-x axis, which denotes an abduction/adduction axis. The axis 238 may be referred to as a first hip-z axis, which denotes a pronation/supination axis. FIG. 2B shows a set of reference axes to illustrate the x, y and z directions, although the actual x, y, and z axes in the robot 200 need not be mutually orthogonal or extend from the same origin. In some embodiments, rotation about the first hip-y axis 226 may cause the robot leg 202 to swing upward and backward (e.g., in a direction that would enable the robot 200 to walk forward and backward). In some embodiments, rotation about the first hip-x axis 232 may cause the robot leg 202 to swing inward (e.g., toward a center line between the legs 202, 204 of the robot 200) and outward. In some embodiments, rotation about the first hip-z axis may cause the robot leg 202 to rotate the stance of the leg (e.g., twist it to the left or to the right). In some embodiments, the leg member 234 is an upper leg member, which may in turn be connected to a lower leg member 242 at a knee joint 240. In some embodiments, the lower leg member 242 is connected to a foot (e.g., foot 212) at an ankle joint.

In some embodiments, the pelvis base 220 is rotatably connected and/or configured to be rotatably connected to a back member 244 (also referred to herein as a “torso”) of the robot 290. An electric actuator 246 may be disposed between the pelvis base 220 and the back member 244 (e.g., in, between, connected to, and/or part of one or both components). In some embodiments, a first portion of the electric actuator 246 may be fixed to the pelvis base 220, and a second portion of the electric actuator 246 may be fixed to the back member 244. The electric actuator 246 may be configured to rotate the back member 244 relative to pelvis base 220 about an axis (e.g., back-z axis) 248. In some embodiments, the back member 244 is rotatably connected and/or configured to be rotatably connected to a head 210 of the robot 290. An electric actuator 250 may be disposed between the back member 244 and the head 210 (e.g., in, between, connected to, and/or part of one or both components). In some embodiments, a first portion of the electric actuator 250 may be fixed to the head 210 and a second portion of the electric actuator 250 may be fixed to the back member 244. The electric actuator 250 may be configured to rotate the head 210 relative to the back member 244 about an axis (e.g., neck-z axis) 252.

In some embodiments, a first shoulder member 256 is rotatably connected and/or configured to be rotatably connected to a back member 244 of the robot 290. An electric actuator 254 may be disposed between the back member 244 and the first shoulder member 256 (e.g., in, between, connected to, and/or part of one or both components). In some embodiments, a first portion of the electric actuator 254 may be fixed to the first shoulder member 256, and a second portion of the electric actuator 254 may be fixed to the back member 244. The electric actuator 254 may be configured to rotate the first shoulder member 256 relative to the back member 244 about an axis (e.g., shoulder-y axis) 258. In some embodiments, the first shoulder member 256 is rotatably connected and/or configured to be rotatably connected to a first intermediate arm member 260 of the robot 290. An electric actuator 262 may be disposed between the first shoulder member 256 and the first intermediate arm member 260 (e.g., in, between, connected to, and/or part of one or both components). In some embodiments, a first portion of the electric actuator 262 may be fixed to the first intermediate arm member 260, and a second portion of the electric actuator 262 may be fixed to the first shoulder member 256. The electric actuator 262 may be configured to rotate the first intermediate arm member 260 relative to the first shoulder member 256 about an axis to provide adduction/abduction of the first intermediate arm member 260 relative to the first shoulder member 256. In some embodiments, a first upper arm member 264 is rotatably connected and/or configured to be rotatably connected to the first intermediate arm member 260 of the robot 290. An electric actuator 266 may be disposed between the first arm member 264 and the first intermediate arm member 260 (e.g., in, between, connected to, and/or part of one or both components). In some embodiments, a first portion of the electric actuator 266 may be fixed to the first arm member 264, and a second portion of the electric actuator 266 may be fixed to the first intermediate arm member 260. The electric actuator 266 may be configured to rotate the first arm member 264 relative to the first intermediate arm member 260 about an axis (e.g., shoulder-z axis) 268.

In some embodiments, the first arm member 264 may in turn be connected to a first lower arm member 272 at a first elbow joint. An electric actuator 270 may be disposed between the first arm member 264 and the first lower arm member 272 (e.g., in, between, connected to, and/or part of one or both components). In some embodiments, a first portion of the electric actuator 270 may be fixed to the first arm member 264, and a second portion of the electric actuator 270 may be fixed to the first lower arm member 272. The electric actuator 270 may be configured to rotate the first arm member 264 relative to the first lower arm member 272 about an axis that provides flexion/extension of the first lower arm member 272 relative to the first arm member 264. In some embodiments, rotation about the first elbow joint may be greater than 90 degrees. In some embodiments, rotation about the first elbow joint may be greater than 180 degrees.

In some embodiments, the first lower arm member 272 is connected to an end effector (e.g., a gripper or hand) via a wrist component. The wrist component may contain one or more actuators configured to provide various ranges of motion to the wrist of the robot. In some embodiments, a second shoulder member, second intermediate arm member, second upper arm member, and second lower arm member are connected in similar fashion to the first shoulder member, first intermediate arm member, first upper arm member, and first lower arm member using similar actuators rotating along similar additional axes and/or providing similar independently actuatable degrees of freedom.

A mobile robot (e.g., robot 200, robot 290, etc.) may include one or more controllers (e.g., controller 108) configured to control operation of one or more actuators of the robot to enable the robot to move one or more robot members coupled to corresponding joints associated with the actuator(s). As described above, the inventors have recognized and appreciated that a control architecture that includes separate controllers for controlling (1) whole body behaviors and (2) robotic manipulation may provide benefits compared with a control architecture that includes a single control algorithm configured to control all movements of the robot.

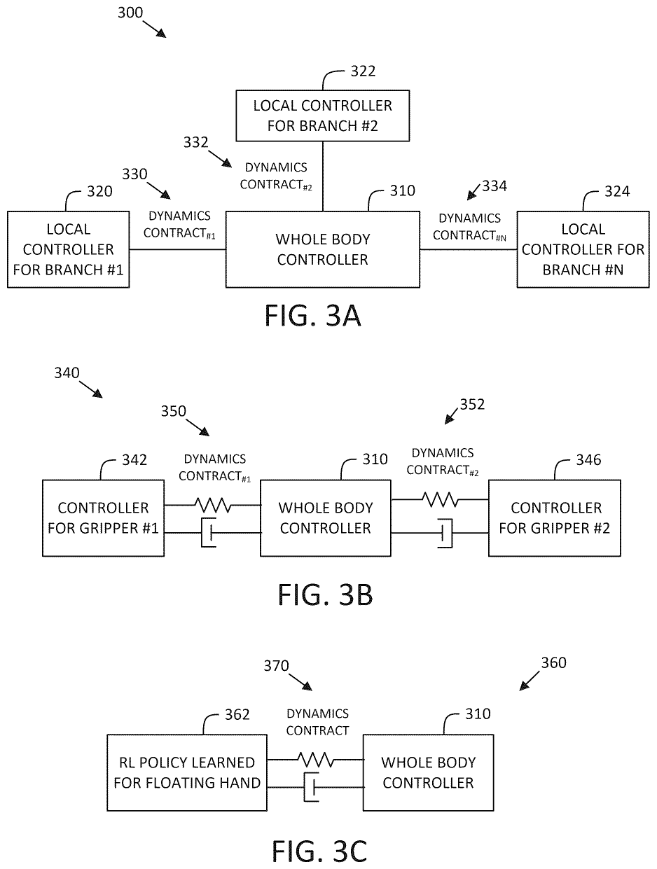

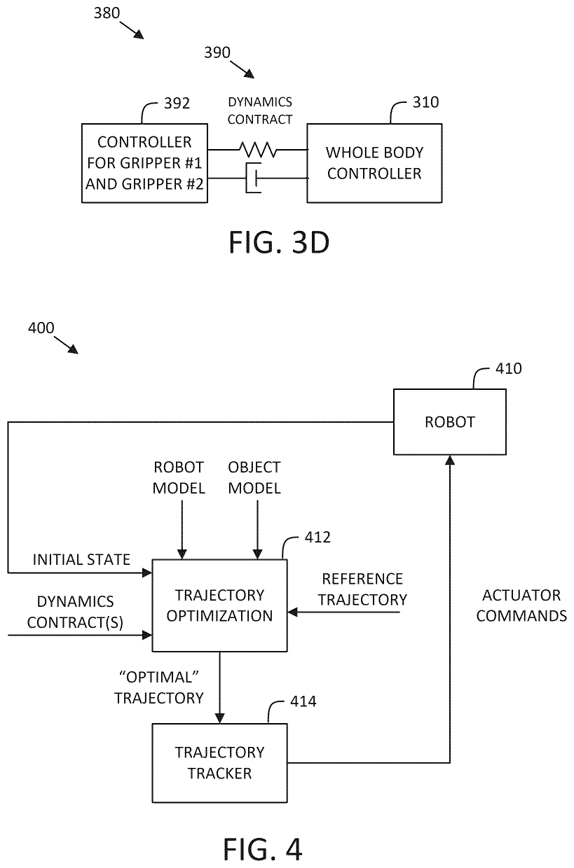

FIG. 3A schematically illustrates a control architecture 300 including multiple controllers, in accordance with some embodiments. Control architecture 300 includes whole body controller 310 and a set of local controllers. Whole body controller 310 may be configured to control the momentum and kinematic configuration of a robot to enable the robot to achieve, for example, dynamic balancing, reaching, stepping, or other dynamic movements. An example of whole body controller 310 is shown in connection with FIG. 4, described in more detail below. Each of the local controllers in the set of local controllers may be configured to control members in a branch or portion of the robot. It should be appreciated that a branch of the robot may include a single articulated end effector, multiple articulated end effectors, or any other portion of the robot. In some embodiments, a single local controller may be configured to control members in two articulated end effectors to perform a bimanual task. In the example shown in FIG. 3A, control architecture 300 includes N local controllers including a first local controller 320 configured to control a first branch/portion of a robot, a second local controller 322 configured to control a second branch/portion of the robot, and an nth local controller 324 configured to control an nth branch/portion of the robot. It should be appreciated that the set of local controllers may include any suitable number of controllers (i.e., N may take any suitable value). For instance, in some implementations, a control architecture may include a single local controller (i.e., N=1), an example of which is described in connection with FIG. 3C. In other implementations, the set of local controllers may include more than one local controller. FIG. 3B depicts an example of a control architecture including two local controllers, each of which is configured to control movement of members in a different gripper of a robot.

Each local controller in the set of controllers may coordinate its behavior with a whole body controller 310 via a dynamics contract that both the whole body controller 310 and the corresponding local controller impose at their interface. For instance, a first dynamics contract 330 may be imposed at the interface between whole body controller 310 and first local controller 320, a second dynamics contract 332 may be imposed at the interface between whole body controller 310 and second local controller 322, and an Nth dynamics contract 334 may be imposed at the interface between whole body controller 310 and Nth local controller 324 As discussed in more detail below, in some embodiments, a dynamics contract may be implemented as a mechanical impedance contract (also referred to herein more simply as an “impedance contract” or “impedance module”), in which an effort signal (e.g., one or more forces) to be rendered by the whole body controller 310 in response to a flow signal (e.g., a linear velocity/position of a specific point fixed to one of the robot's members relative to a reference value) is specified. In some embodiments, the flow signal (e.g., velocity and/or position) may be provided from the local controller to the whole body controller 310 in Cartesian space for the base member (e.g., most proximal member) of the branch associated with the local controller and in joint space for more downstream (e.g., distal) members of the branch (e.g., finger members of an end effector branch). In some embodiments, the impedance contract may specify a stiffness and/or damping in linear and angular directions that the whole body controller 310 should be able to render at a particular point in time.

FIG. 3B schematically illustrates a control architecture 340 that includes a whole body controller 310, a first local controller 342 configured to control behavior of a first gripper of a robot, and a second local controller 346 configured to control behavior of a second gripper of the robot. As shown, control architecture 340 imposes a first impedance contract 350 at the interface between whole body controller 310 and local controller 342 and a second impedance contract 352 at the interface between whole body controller 310 and local controller 346. As described above, separating the whole body control functions performed by the whole body controller 310 and the manipulation control functions performed by the local controller (e.g., local controller 342) enables control policies for each of these components to be configured and/or learned independently from each other, which may improve the flexibility and/or scalability of the control architecture 340 relative to a control architecture where both whole body control and end effector control are managed by a single controller. For instance, use of multiple controllers and an impedance contract configured to coordinate operation of the multiple controllers enables local policies trained to control a portion of the robot to only be concerned with movements of the members in the portion of the robot it is controlling without having to consider the underlying whole body dynamics of the robot during training.

In some embodiments, whole body controller 310 may be implemented as model-based controller (e.g., a model predictive controller) configured to compute several different outputs for the robotic device over a specified time horizon (e.g., a period of 1 second, 1.2 seconds, 1.5 seconds, etc.). Examples of such outputs may include, but are not limited to, trajectories for the robot's joint positions and joint torques, a trajectory for the position of the robot's center of mass, a momentum of the robot's center of mass, an angular momentum of the robot's center of mass, or an angular excursion and/or a trajectory of contact wrenches applied at some subset of members or links of the robot. Such outputs may be used to enable the robot to achieve whole body control functions such as dynamic balance, reaching, collision avoidance, and/or locomotion (e.g., stepping). In some embodiments, the whole body controller may, at least in part, be implemented as a learned policy. Such a learned policy may be trained, for example, by reinforcement learning, behavior cloning, or other suitable control policy learning techniques.

In some embodiments, one or more local controllers in the set of local controllers may implement a learned policy. FIG. 3C schematically illustrates a control architecture 360 in accordance with some embodiments that includes a whole body controller 310 and a local controller 362 configured to implement a learned policy for a hand (e.g., a “floating hand,” as shown), with the learned policy being trained using reinforcement learning. Training of the learned policy may be performed without having to consider how the whole body controller 310 will perform control of whole body dynamics during operation of the robot. For instance, stiffness and/or damping information may be specified as input to the process for training the learned policy and the stiffness and/or damping information used during training may be provided from the local controller 362 to the whole body controller 310 during robot operation. A dynamics contract 370 may coordinate control between the local controller 362 and the whole body controller 310. During operation of the robot, the local controller 362 may execute the learned policy to output a desired behavior of the robot's gripper. Reference trajectory information associated with movement of the gripper may be provided to the whole body controller along with information about the stiffness and/or damping values used during training of the local policy, as described above. In this way, the impedance contract 370 provides a layer of compliance, by which the local controller 362 “puppets” the robot body, while the whole body controller 310 tracks the position/velocity reference signal produced by the local controller using the specified impedance in the impedance contract.

As described above, in some embodiments, the whole body controller 310 may be implemented as a model predictive controller according to a receding horizon scheme where an objective for future goals (e.g., over a 1 second horizon) is continuously provided (e.g., at an update rate of 100 Hz). The inventors have recognized and appreciated that predicting future goals over a horizon on the timescale of the whole body controller 310 may be particularly difficult for manipulation behaviors where the interaction with the environment may be uncertain and/or poorly observed by the sensors of the robot. Accordingly, rather than impose the receding horizon scheme on the outputs of the local controller, the local controller may be implemented as a learned policy configured to provide goals over a much shorter timespan (e.g., instantaneous goals) as the end effector controlled by the local controller interacts with the environment. Such an approach may, for example, enable local control polices for the end effector to make fine and/or quick adjustments to the grip of an object in the end effector based on local contact sensing (e.g., tactile sensing) using sensors in the gripper that may not be possible, or may be more challenging, if such sensor data were processed by the whole body controller 310. It should be appreciated, however, that not all embodiments of the present disclosure require the whole body controller and the local controller(s) in the set of controllers to operate according to different planning horizons. Rather, in some embodiments the planning horizons of the whole body controller and the local controller(s) may be the same or substantially the same.

In some embodiments, a single local controller may be configured to control a portion of the robot that includes multiple end effectors. For example, a single local controller may be configured to control a first end effector and a second end effector to perform a bimanual interaction with an environment of the robot, such as grasping a box with two opposed grippers, rotating a handle of a valve with two grippers placed on opposite sides of the handle, etc. FIG. 3D schematically illustrates a control architecture 380 in accordance with some embodiments that includes a whole body controller 310 and a local controller 392 configured to control a first gripper and a second gripper of a robot. A dynamics contract 390 may coordinate control between the local controller 392 and the whole body controller 310. During operation of the robot, the local controller 392 may execute a learned policy trained to control the first gripper and the second gripper to perform a bimanual interaction with an environment of the robot, such as using both grippers to rotate a valve or carry an object. Reference trajectory information associated with movement of each of the first gripper and the second gripper may be provided to the whole body controller along with information about the stiffness and/or damping values used during training of the learned policy implemented by the local controller 392.

FIG. 4 schematically illustrates an architecture 400 for a model predictive controller, in accordance with some embodiments of the present disclosure. As described herein, such a model predictive controller architecture may be used as a whole body controller 310 in a control architecture of a robot, examples of which are described herein in connection with FIGS. 3A-3C. Architecture 400 includes a trajectory optimization engine 412 configured to predict an “optimal” trajectory of a robot over a time horizon (e.g., up to 1 second into the future). The trajectory optimization engine 412 may take as input a model of the robot 410 and a model of an object with which the robot 410 is to interact. For instance, the robot model may include an accurate model of the dynamics of the robot 410 that includes detail about all of the joints and links/members included in the robot 410. The object model may include object information, such as the object's mass, size, shape, etc. The trajectory optimization engine 412 may further take as input, an initial state of the robot 410, which may be derived using sensor information (e.g., from encoders) configured to measure the current positions of the joints of the robot 410. The trajectory optimization engine 412 may take as further input, a reference trajectory, which may specify, for example, end effector goals (e.g., in Cartesian space) and/or an expected contact mode of the end effector with the object. Trajectory optimization engine 412 may be configured to solve a non-linear trajectory optimization based on the provided inputs at a specified rate (e.g., 100 Hz), such that the “optimal” trajectory over a specified time horizon is continuously provided as output from non-linear trajectory optimization to trajectory tracker 414. Trajectory tracker 414 may be configured to issue a set of actuator commands to the actuators of robot 410 to control its movement based on the optimal trajectory determined by the trajectory optimization engine 412. Although shown as separate components from robot 410, it should be appreciated that trajectory optimization engine 412 and/or trajectory tracker 414 may be implemented by one or more hardware computer processors included as a portion of robot 410.

In some embodiments, one or more objectives (e.g., impedance objectives) as specified in one or more dynamics contracts with local controllers for controlling branches of the robot may be applied to the optimization performed by the trajectory optimization engine 412 as shown. Inclusion of such objectives in the optimization may provide a layer of compliance to the whole body controller that may be used to simultaneously satisfy the objectives of performant whole body control and performant manipulation through local end effector control for the robot 410.

As discussed herein, controlling a mobile robot to simultaneously achieve whole body control and interaction with a robot's environment (e.g., with an end effector of the robot) is a complex process for a single control algorithm to accomplish using, for example, an end-to-end control model. Some embodiments of the present disclosure simplify the complexity of manipulation with a balancing robot using a control architecture that includes two or more controllers—a whole body controller configured to control whole-body dynamics of the mobile robot (e.g., for dynamic balance and/or locomotion) and at least one local controller configured to control an end effector of the robot to interact with the environment of the robot. Behavior of the whole body controller with the local controller(s) can be mediated by one or more dynamics contracts (e.g., impedance contracts that specify a stiffness and/or damping, such as in SE(3) terms) that the whole body controller should attempt to render at a point in time. Reference trajectory information associated with movement of the portion of the robot under control of the local controller(s) may be provided to the whole body controller during movement according to a local learned policy implemented by the local controller.

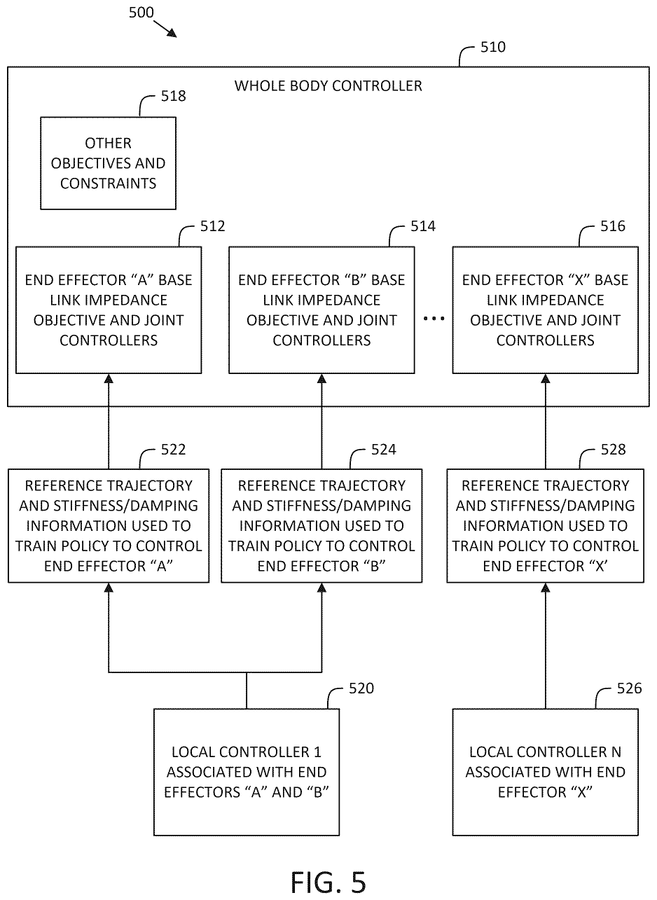

FIG. 5 illustrates a control system 500 for controlling a robot, in accordance with some embodiments of the present disclosure. Control system 500 includes a whole body controller 510 and one or more local controllers, examples of which include local controller 520 associated with end effectors “A” and “B” and local controller 526 associated with local controller “X.” Local controller 520 may be configured to execute a first control policy for controlling end effectors A and B to perform a bimanual interaction with an environment of the robot. For instance, the first control policy may be a learned policy trained using a simulation of a first disembodied hand corresponding to the end effector A and a second disembodied hand corresponding to the end effector B. Each of end effector A and end effector B may include a base member and one or more distal members (e.g., fingers) coupled to the base member. During training of the learned policy, an impedance controller (e.g., an SE(3) impedance controller) may perform control of the base members of end effector A and end effector B based stiffness and/or damping parameters provided as input to the impedance controller. In some embodiments, domain randomization over SE(3) end effector inertia may be performed during training of the learned policy. A similar learning process may be used to train a learned policy for other local controllers, such as local controller 526.

During operation of the robot to perform the end effector interaction associated with a corresponding learned policy, data associated with each end effector associated with a local controller may be provided from the local controller to the whole body controller as shown in FIG. 5. In particular, reference trajectory information (e.g., position/velocity information of a point on a corresponding end effector) and information used to train the learned policy used to control the end effector (e.g., stiffness and/or damping information provided as input during the training) may be provided to the whole body controller. As shown in FIG. 5, local controller 520 may be configured to provide first information 522 including reference trajectory information for end effector A and stiffness/damping information used to train a policy to control end effector A to control component 512 in whole body controller 510 configured to output joint control information for end effector A. In embodiments in which the whole body controller 510 is a model predictive controller that predicts robot behavior over a time horizon, the reference trajectory information included in the first information may include reference trajectory information up to the time horizon implemented by the model predictive controller. As discussed above, end effector A may include a base member and one or more downstream or distal members coupled to the base member. In such instances, the first information may include for the base member, in Cartesian space (e.g., according to SE(3)), pose reference trajectory information and stiffness and/or damping information that was used for the base member during training of the learned policy. The first information may further include for the downstream member(s), in joint space, reference trajectories and stiffness and/or damping information that was used during training of the learned policy.

Similarly, local controller 520 may be configured to provide second information 524 including reference trajectory information for end effector B and stiffness/damping information used to train a policy to control end effector B to control component 514 in whole body controller 510 configured to output joint control information for end effector B. It should be appreciated that in some embodiments, a single learned policy for controlling end effector A and B may be implemented by local controller 520. In other embodiments, multiple learned policies may be used. Continuing with the example of FIG. 5, local controller 526 may be configured to provide third information 528 including reference trajectory information for end effector X and stiffness/damping information used to train a policy to control end effector X to control component 516 in whole body controller 510 configured to output joint control information for end effector X. The whole body controller 510 may use the information provided from the local controllers along with other objectives and constraints to determine an optimal trajectory for the robot as described, for example, in connection with the whole body controller shown in FIG. 4.

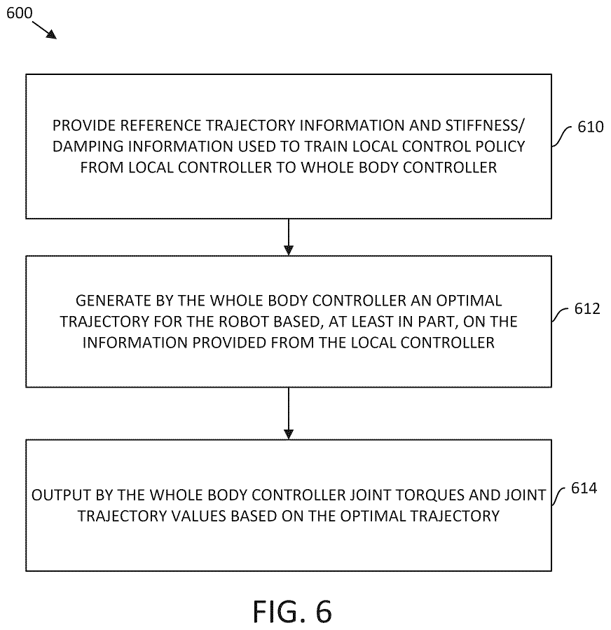

FIG. 6 illustrates a process 600 for coordinating control of a local end effector with a whole body controller using a dynamic contract, according to some embodiments of the present disclosure. Process 600 may begin in act 610, where reference trajectory information and stiffness and/or damping information used to train a local control policy is provided from a local controller of the robot to a whole body controller of the robot, for example, as discussed above in connection with control system 500 shown in FIG. 5. Process 600 may then proceed to act 612, where the whole body controller may determine an “optimal” trajectory for the robot based, at least in part, on the information provided from the local controller, as described for example, with reference to the whole body controller of FIG. 4. For instance, the whole body controller may perform an optimization that attempts to provide appropriate joint torques and trajectory values at the interface to the end effector that the local policy expects based on its training. Process 600 may then proceed to act 614, where the whole body controller outputs joint torques and joint trajectory values in accordance with the optimal trajectory.

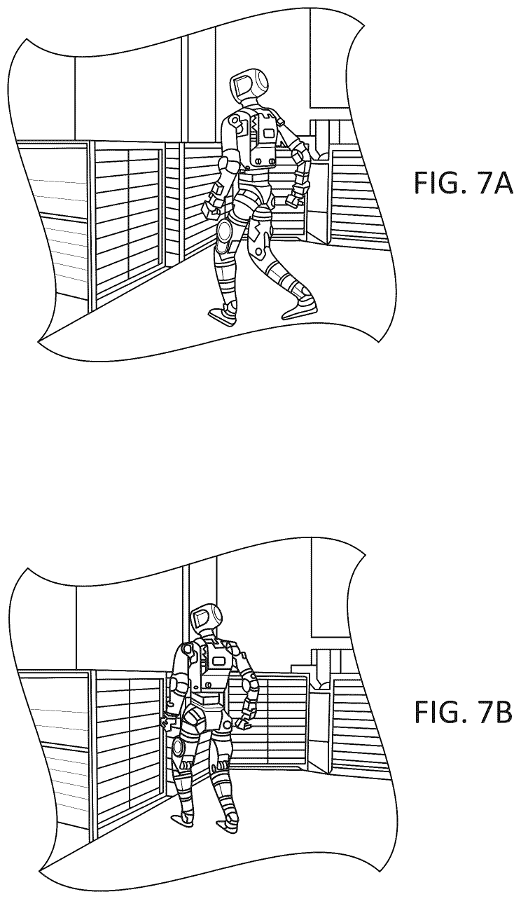

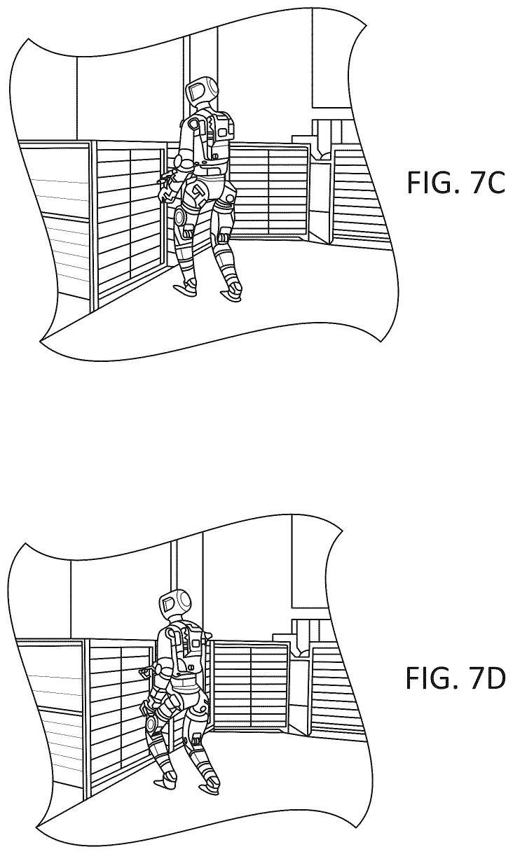

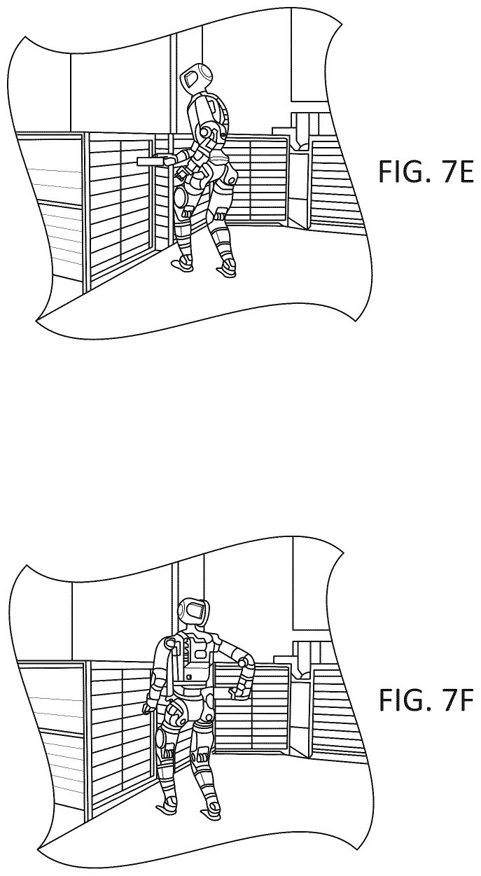

FIGS. 7A-7F depict a robot configured to implement a control architecture as described herein to perform an object manipulation task. In FIG. 7A, the robot is shown as walking toward a shelf with whole body control being performed by a whole body controller. In FIG. 7B, the whole body controller controls the robot to choose a stance to grasp an object. In FIG. 7C, the robot cedes control of the right gripper to a local gripper policy (e.g., learned with reinforcement learning, as described herein). In FIG. 7D, the local gripper policy is executed to move the gripper inside of a slot to grasp an object while the whole body controller accommodates this movement via a dynamics contract between the local controller and the whole body controller, as described herein. In FIG. 7E, the robot extracts the object from the slot according to the local gripper policy and the whole body controller accommodates this movement via the dynamic contract. In FIG. 7F, the whole body controller of the robot regains control of the entire body of the robot to enable the robot to walk while grasping the object.

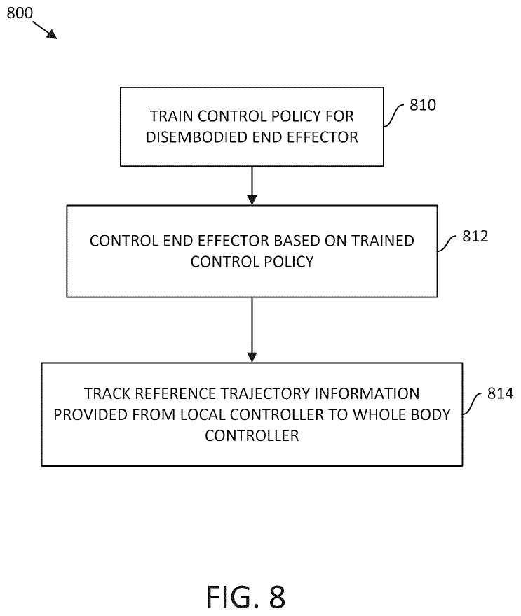

FIG. 8 is a flowchart of a process 800 for controlling an end effector based on a learned local policy, in accordance with some embodiments of the present disclosure. Process 800 may begin in act 810, where a learned policy for an end effector is trained for a disembodied end effector, or other portion of a simulated robot body. For example, a hand (e.g., a floating hand) may be used to train a control policy for a robot end effector. Training of the learned policy may be accomplished, for example, using a reinforcement learning technique or some other machine learning technique, examples of which are provided herein. Any suitable learning technique may be used to train a learned policy, examples of which include behavior cloning and reinforcement learning among others. It should be appreciated that different learning techniques may be used for different learning policies implemented on a robot in accordance with the techniques described herein. For instance, a first learned policy may be trained using simulations of a behavior using reinforcement learning and a second learned policy may be trained using behavior cloning based on observations of a human demonstrating the behavior.

Process 800 may then proceed to act 812 where the end effector is controlled based on the trained control policy. In some embodiments, a robot may include a set of learned policies for an end effector, which may be executed in sequence to perform a more complex task. For example, the set of learned policies may include a first policy to grasp an object with an end effector, a second policy to rotate the object when grasped by the end effector, and a third policy to place the grasped object at a location in the environment. The robot may be configured to execute the first policy followed by the second policy followed by the third policy to move an object from a first location in the environment to a second location in the environment. In this way, the set of learned end effector policies may be represented as building blocks that may be combined to render more complex end effector behaviors. One or more of the learned policies may be configured to adjust manipulation of the object based on sensor information (e.g., local tactile sensor information) in a closed loop fashion without sending such sensor information to a whole body controller of the robot. It should be appreciated that the learned policy may be trained to enable the end effector to manipulate objects that may be fixed to infrastructure in the environment (e.g., knobs, valves, handles, ladders, etc.) and/or objects that may be movable by the robot within the environment (e.g., objects that may be lifted and moved from a first shelf to a second shelf in a warehouse).

To allow the whole body controller of the robot to accommodate the movement of the end effector in act 812, process 800 may proceed to act 814, where the whole body controller tracks reference trajectory information provided from the local controller based on the trained control policy, as described herein.

As should be appreciated, decoupling robot interaction control for one or more end effectors of a robot from whole body control of the robot using a control architecture as described herein, enables a variety of local interaction policies to be learned for manipulating different objects in different ways to perform different tasks, without having to consider the whole body dynamics of the robot when the local policies are learned. For example, simulations using representations of disembodied robot portions may be used to train local interaction policies without having to consider the whole body dynamics of the robot. The learned policies may then be deployed on the robot to configure the robot to perform the specific interactions with the environment of the robot without updating the robot's whole body controller. The impedance contract between the whole body controller and the local controller may ensure that the whole body controller can accommodate the movements of the portion of the robot controlled by the local interaction policy during robot operation.

Additionally, the same local learned policy may be executed on any part of the reachable workspace of the robot, greatly improving the extensibility of the control capabilities of the robot relative to using a whole body behavior policy to also perform environment interaction (e.g., object manipulation) tasks, which may need to address the body configuration of the robot across the workspace. For instance, the same end-effector task policy may be executed when the gripper is in front of the robot, behind the robot, on the left of the robot, on the right of the robot, with the arm extended upward or downward toward a surface, or in any possible gripper configuration within the robot's workspace.

A number of implementations have been described. Nevertheless, it will be understood that various modifications may be made without departing from the spirit and scope of the disclosure.

1. A control system for a mobile robot, the control system comprising:
a first controller configured to control movement of the mobile robot to provide dynamic balancing of the mobile robot;
a second controller configured to control movement of a first portion of the mobile robot; and
a first dynamics module configured to coordinate operation of the first controller and the second controller.

2-4. (canceled)

5. The control system of claim 1, wherein the first portion of the mobile robot includes at least one end effector.

6. The control system of claim 5, wherein the first portion of the mobile robot includes at least two end effectors.

7. The control system of claim 1, wherein the second controller is configured to control movement of the first portion of the mobile robot to interact with an environment of the mobile robot.

8. The control system of claim 7, wherein the second controller is configured to control movement of the first portion of the mobile robot to grasp and/or manipulate an object.

9. (canceled)

10. The control system of claim 7, wherein the second controller comprises a learned control policy trained using reinforcement learning.

11. The control system of claim 1, wherein the first dynamics module comprises an impedance module.

12. The control system of claim 1, wherein
the second controller is comprises a learned control policy,
the first controller is configured to provide reference trajectory information and learned control policy information,
the reference trajectory information comprises position and/or velocity information for the first portion of the mobile robot, and
the learned control policy information comprises stiffness and/or damping information used during training of the learned control policy.

13. (canceled)

14. The control system of claim 12, wherein
the first portion of the mobile robot includes a base member and at least one downstream member distal from the base member, and
the reference trajectory information comprises:
an SE(3) pose reference trajectory for the base member; and
a joint position reference trajectory for the at least one downstream member.

15. (canceled)

16. The control system of claim 12, wherein
the first portion of the mobile robot includes a base member and at least one downstream member distal from the base member, and the learned control policy information comprises:
SE(3) stiffness and/or damping information used during training of the learned control policy to control the base member; and
joint space stiffness and/or damping information used during training of the learned control policy to control the at least one downstream member.

17. The control system of claim 1, further comprising:
a third controller configured to control movement of a second portion of the mobile robot; and
a second dynamics module configured to coordinate operation of the first controller and the third controller.

18-19. (canceled)

20. The control system of claim 1, wherein the first dynamics module is configured to coordinate operation of the first controller and the second controller by specifying impedance information at an interface between the first controller and the second controller.

21. A robot, comprising:
a body;
a set of articulated appendages coupled to the body, the set of articulated appendages including at least one leg and a first robotic arm, the first robotic arm including a first wrist joint coupling a first end effector to the first robotic arm;
a whole body controller configured to:
manage whole body dynamics of the robot; and
a first end effector controller configured to control movement of the first end effector based on a first learned policy trained independently of the whole body dynamics of the robot.

22. The robot of claim 21, wherein managing whole body dynamics of the robot comprises controlling the robot to perform dynamic balancing and/or controlling the robot to perform locomotion.

23-25. (canceled)

26. The robot of claim 21, wherein
the first end effector comprises a gripper, and
controlling movement of the first end effector to interact with an environment of the robot comprises controlling movement of the first end effector to manipulate an object by one or more of grasping the object, in-gripper manipulation of the object, using a grasped object to perform a task, or releasing the object from a grasp of the gripper.

27. The robot of claim 21, wherein
the set of articulated appendages further includes a second robotic arm including a second wrist joint coupling a second end effector to the second robotic arm, and
the robot further comprises:
a second end effector controller configured to control movement of the second end effector based on a second learned policy trained independently of the whole body dynamics of the robot.

28. The robot of claim 27, wherein the first learned policy and the second learned policy are configured to enable the robot to perform a bimanual interaction with an environment of the robot using the first end effector and the second end effector.

29. The robot of claim 21, wherein
the set of articulated appendages further includes a second robotic arm including a second wrist joint coupling a second end effector to the second robotic arm, and
a first end effector controller is further configured to control movement of the second end effector based on the first learned policy or a second learned policy.

30-32. (canceled)

33. The robot of claim 21, wherein
the first end effector comprises at least one tactile sensor, and
the first end effector controller is further configured to control movement of the first end effector based on data sensed by the at least one tactile sensor.

34-39. (canceled)

40. A method of controlling a legged robot, the method comprising:
controlling, with a whole body controller, whole body dynamics of the legged robot; and
controlling, using a local controller associated with an end effector of the legged robot, movement of the end effector to interact with an environment of the legged robot while the whole body controller performs whole body control of the legged robot.
